(19) United States
(12) Patent Application Publication
(10) Pub. No.: US 2013/0222304 A1
(43) Pub. Date: Aug. 29, 2013

(54) CONTROL APPARATUS

(71) Applicant: DENSO CORPORATION, (US)

(72) Inventors: Kiyotaka TAGUCHI, Kariya-city (JP); Toru NADA, Inazawa-city (JP); Makoto MANABE, Chiryu-city (JP); Shinji HATANAKA, Okazaki-city (JP); Norio SANMA, Okazaki-city (JP); Akira YOSHIZAWA, Koganei-city (JP); Makoto OBAYASHI, Kashiwa-city (JP)

(73) Assignee: DENSO CORPORATION, Kariya-city (JP)

(21) Appl. No.: 13/773,695

(22) Filed: Feb. 22, 2013

(30) Foreign Application Priority Data
Feb. 29, 2012 (JP) 2012-44197

(51) Int. Cl. G06F 3/041

(52) U.S. Cl. CPC G06F 3/041
USPC 345/173

(57) ABSTRACT

A CPU of a control apparatus identifies a driver's manipulatable range, calculates compensation parameters, and sets the compensation parameters to be used for a compensation process. As a result, since the manipulation signal is compensated, e.g., to expand manipulation trajectories based on the driver's manipulatable range, a manipulation content can be recognized accurately.

### CROSS REFERENCE TO RELATED APPLICATION

The present application is based on Japanese Patent Application No. 2012-44197 filed on Feb. 29, 2012, the disclosure of which is incorporated herein by reference.

### TECHNICAL FIELD

The present invention relates to a control apparatus that processes signals outputted from a touchpad provided to a steering wheel of a vehicle.

### BACKGROUND ART

[Patent Literature 1] JP 2009-298285 A

In recent years, devices that are called touchpads and receive various manipulation instructions are being used. The touchpad can detect a position on its manipulation surface touched and pushed by a user. Some touchpads can also detect manipulation pressures. Techniques of the detection include various ones such as a technique of detecting a change of an electrostatic capacity, a technique of detecting a change of a resistance, and a technique of detecting a strain of a support portion on a manipulation surface.

It is proposed that such a touchpad is built into a steering wheel of a vehicle and a driver can manipulate the touchpad while holding the steering wheel by hands. For example, a technique of Patent Literature 1 is known.

When a driver can manipulate a touchpad while holding a steering wheel, it is assumed that the driver manipulates the touchpad mainly by fingers while palming the steering wheel. That is, it is assumed that the driver moves their fingertip about the base of the finger to manipulate the touchpad. However, since lengths of fingers are different among drivers, a manipulatable range on a manipulation surface of the touchpad changes among the drivers.

Suppose that a content of a manipulation to a touchpad is recognized on the assumption that such a manipulation is performed by a person having long fingers. This case may decrease a recognition rate of a content of a manipulation by a person having short fingers. On the contrary, suppose that a content of a manipulation to the touchpad is recognized on the assumption that such a manipulation is performed by a person having short fingers. This case may decrease a recognition rate of a content of a manipulation by a person having long fingers.

### SUMMARY

It is an object of the present disclosure to provide a control apparatus to accurately recognize a manipulation content inputted to a touchpad provided to a steering wheel of a vehicle, for instance.

To achieve the above object, according to an example of the present discloser, a control apparatus for a vehicle is provided to include an input portion, a manipulatable range identification section, a compensation section, and a compensated signal output portion. The input portion inputs a signal based on a manipulation performed on a manipulation surface of a touchpad, which is positioned to be manipulatable in a steering-wheel holing state that is a state where a steering wheel of the vehicle is held by a hand of a driver of the vehicle. The manipulatable range identification section identifies a manipulatable range on the manipulation surface of the touchpad based on the signal inputted by the input portion. The compensation section compensates the signal based on the manipulatable range to expand or reduce a manipulation trajectory identified by the signal inputted by the input portion. The compensated signal output portion outputs the signal compensated by the compensation section. The above “signal” may be analog or digital. The compensated signal may be outputted to a control apparatus having a different function.

According to another example of the present discloser, a method is provided for compensating a manipulation on a touchpad in a vehicle. The method is computer-implemented for execution by a computer. The method includes: (i) inputting a signal based on a manipulation performed on a manipulation surface of the touchpad, which is positioned to be manipulatable in a steering-wheel holing state that is a state where a steering wheel of the vehicle is held by a hand of a driver of the vehicle; (ii) identifying a manipulatable range on the manipulation surface of the touchpad based on the signal inputted; (iii) compensating the signal based on the manipulatable range to expand or reduce a manipulation trajectory identified by the signal inputted; and (iv) outputting the signal that is compensated.

With such a control apparatus or a method, based on a driver's manipulatable range, the signal is compensated to expand or reduce the manipulation trajectory. Therefore, an accurate manipulation content can be recognized using the signal that is compensated.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram to explain a structure of a control apparatus according to an embodiment of the present disclosure and other apparatuses or devices connected the control apparatus;

FIG. 2 is a front view (from a driver's view) of a steering wheel of a vehicle;

FIG. 3 is a flowchart to explain a compensation parameter setting;

FIG. 4A is an explanatory view to explain a manipulatable range;

FIG. 4B is an explanatory view to explain a pressure map;

FIG. 4C is an explanatory view to explain an angle of a thumb;

FIG. 5 is an explanatory view to explain an example of divisional areas of a manipulatable range;

FIG. 6 is an explanatory view showing an example of a relation between a reference manipulation pressure line and a driver manipulation pressure line;

FIG. 7 is a flowchart to explain a compensation process;

FIG. 8A is an explanatory view to explain an example of compensation;

FIG. 8B is an explanatory view to explain an example of the compensation;

FIG. 8C is an explanatory view to explain an example of the compensation;

FIG. 8D is an explanatory view to explain an example of the compensation;

FIG. 8E is an explanatory view to explain an example of the compensation; and

FIG. 8F is an explanatory view to explain an example of the compensation.

### DETAILED DESCRIPTION

Hereafter, embodiments to which the present disclosure is applied is described using the appended drawings.

### First Embodiment

[Explanation of Structure]

(1) Connection of Control Apparatus 11

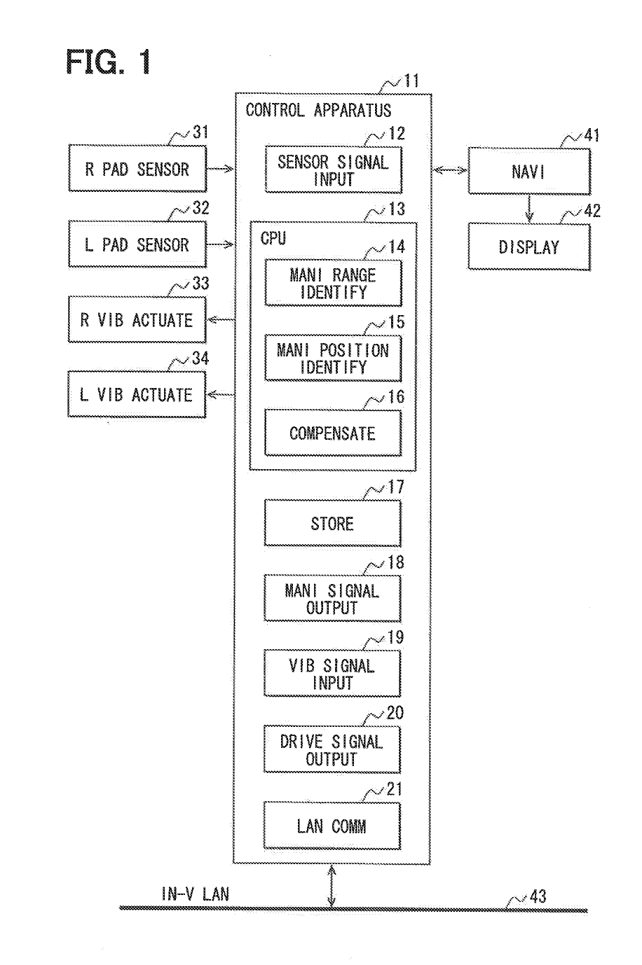

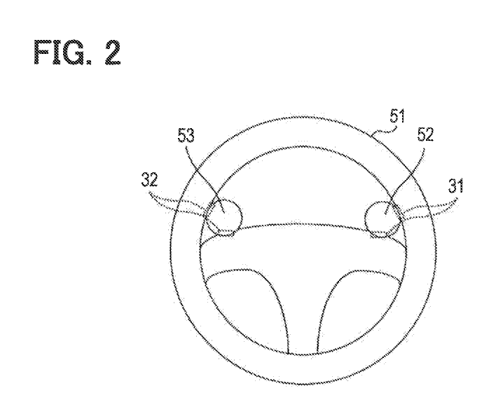

First, a connection of a control apparatus 11 of an embodiment is explained using FIGS. 1 and 2.

As shown in FIG. 1, the control apparatus 11 is provided in a vehicle and connected to a right pad sensor 31, a left pad sensor 32, a right vibration actuator 33, a left vibration actuator 34, a navigation apparatus 41, a display apparatus 42, and an in-vehicle LAN (Local Area Network) 43.

The right pad sensor 31 is provided to a right touchpad 52 that is positioned to be manipulatable by the right thumb of a driver who is holding a steering wheel 51 by hands or palms; the right touchpad 52 has a generally disk shape. Further, it is noted that a steering-wheel holding state is defined as a state where a steering wheel of the vehicle is being held by a hand or palm of the driver of the vehicle. The right pad sensor 31 detects a manipulation of the right touchpad 52 by the driver and outputs the detection result as a manipulation signal. The right pad sensor 31 can detect manipulation positions and manipulation pressures on the right touchpad 52. Specifically, the right pad sensor 31 may include, but is not limited to, a strain gauge. The right pad sensor 31 may include any sensor that is capable of detecting manipulation positions and manipulation pressures. The right pad sensor 31 may also include multiple sensors. The manipulation signal may be analog or digital. This is the same for the following “signals.”

The left pad sensor 32 provided to the left touchpad 53 that is positioned to be manipulatable by the left thumb of the driver who is holding the steering wheel 51 by hands or palms; the left touchpad 5 has a generally disk shape, as shown in FIG. 2. The left pad sensor 32 detects a manipulation of the left touchpad 53 by the driver, and outputs the detection result as a manipulation signal. The left pad sensor 32 can detect manipulation positions and manipulation pressures on the left touchpad 53. Specifically, the left pad sensor 32 may include, but is not limited to, a strain gauge. The left pad sensor 32 may include any sensor that is capable of detecting manipulation positions and manipulation pressures. The left pad sensor 32 may also include multiple sensors.

Returning to FIG. 1, the right vibration actuator 33 is built into or positioned near the right touchpad 52. The right vibration actuator 33 vibrates on the basis of vibration signals from the control apparatus 11 to apply vibration to the fingers or palm of the driver.

The left vibration actuator 34 is built into or positioned near the left touchpad 53. The left vibration actuator 34 vibrates on the basis of vibration signals from the control apparatus 11 to apply vibration to the fingers or palm of the driver.

The navigation apparatus 41 is used for display of maps, guidance of recommended routes, notification of traffic information, notification of vehicle information, etc. The navigation apparatus 41 receives a manipulation signal from the control apparatus 11, to recognize a content of the manipulation on the basis of the manipulation signal. The navigation apparatus 41 executes various processes (changing of a scale of a map, a recommended route, a type of traffic information notified, a type of vehicle information notified, etc.) on the basis of the recognition result.

The display apparatus 42 includes a device such as a liquid crystal display, an organic electroluminescence display, etc. and can display various images on the basis of image signals outputted from the navigation apparatus 41.

The in-vehicle LAN 43 is laid in the vehicle. Various ECUs etc. are connected on the LAN and function as communication mediums for communications among them.

(2) Internal Structure of Control Apparatus 11

Next, an internal structure of the control apparatus 11 is explained. As shown in FIG. 1, the control apparatus 11 includes a sensor signal input portion 12, a CPU (Central Processing Unit) 13 (also referred to a computer), a storage portion 17, a manipulation signal output portion 18, a vibration signal input portion 19, an actuator drive signal output portion 20, and an in-vehicle LAN communication portion 21.

The sensor signal input portion 12, which is also referred to as an input portion, device, or means, is an interface to receive manipulation signals outputted from the right pad sensor 31 and left pad sensor 32.

The CPU 13 is a well-known microprocessor and realizes various sections, devices, means, or functions by performing processes on the basis of a program stored in the storage portion 17 etc. mentioned later. As an example, a manipulatable range identification section, device, means, or function 14, a manipulation position and pressure identification section, device, means, or function 15, and a compensation section, device, means, or function 16 are realized.

The manipulatable-range identification section 14 identifies ranges manipulatable by a current driver on the manipulation surfaces of the right touchpad 52 and left touchpad 53 on the basis of the manipulation signals inputted by the sensor signal input portion 12. The manipulatable-range identification section 14 executes S120 in the compensation parameter setting mentioned later as one example.

The manipulation position and pressure identification section 15 identifies (i) manipulation positions and manipulation pressures on the manipulation surfaces of the right touchpad 52 and left touchpad 53 on the basis of manipulation signals inputted by the sensor signal input portion 12. Manipulation positions are positions which the driver touches or to which the driver performs a manipulation; manipulation pressures on the manipulation positions are pressures which are applied to the manipulation positions based on the manipulation performed by the driver. When the driver traces the manipulation surfaces of the right touchpad 52 and left touchpad 53 with a finger, the manipulation position and pressure identification section 15 can identify the traced positions and pressures thereon continuously as manipulation trajectories. The manipulation position and pressure identification section 15 executes S110 in the compensation parameter setting mentioned later as an example.

The compensation section 16 compensates manipulation trajectories identified by the manipulation position and pressure identification section 15 on the basis of the manipulatable range identified by the manipulatable range identification section 14. The compensation section 16 includes a compensation process mentioned later as an example.

The storage portion 17 is structured of a non-volatile storage device such as a flash memory to store a variety of information (information about manipulatable ranges, learning data, etc.), and stores programs read and executed by the CPU 13.

The manipulation signal output portion 18 is an interface to output a manipulation signal to the navigation apparatus 41; the manipulation signal is inputted by the sensor signal input portion 12 and part of the manipulation signal inputted is compensated by the compensation section 16.

The vibration signal input portion 19 is an interface to input a vibration signal from the navigation apparatus 41.

The actuator drive signal output portion 20 is an interface to convert a drive signal inputted by the vibration signal input portion 19 to a drive signal having a voltage required to drive the right vibration actuator 33 and left vibration actuator 34 and to output the converted drive signal to the right vibration actuator 33 and left vibration actuator 34.

The in-vehicle LAN communication portion 21 is a module that communicates with various ECUs via the in-vehicle LAN 43.

[Explanation of Operation]

Next, operation of the control apparatus 11 is explained.

(1) Compensation Parameter Setting

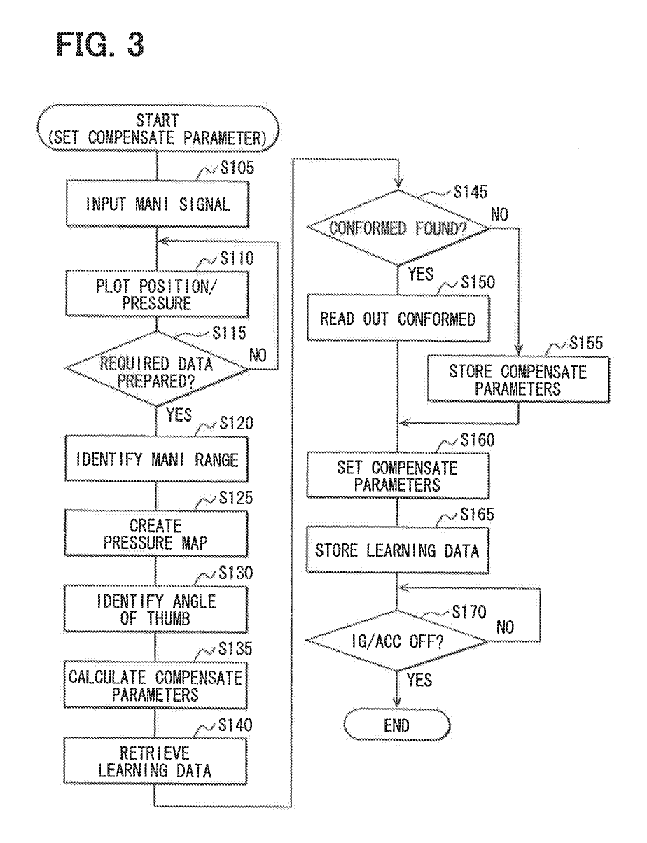

First, a compensation parameter setting is explained using FIG. 3. The compensation parameter setting is performed by the CPU 13 on the basis of a program read from the storage portion 17. The compensation parameter setting is started when an ignition switch (or an accessory switch) of the vehicle is turned on.

It is noted that a flowchart or the processing of the flowchart in the present application includes sections (also referred to as steps), each of which is represented, for instance, as S105. Further, each section can be divided into several sub-sections while several sections can be combined into a single section. Furthermore, each of thus configured sections can be also referred to as a function, module, device, or means.

Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer.

When the compensation parameter setting is started, the CPU 13 starts inputting a manipulation signal via the sensor signal input portion 12 first (S105). Thus, S105 executed by the CPU 13 may function as an input section, device, or means.

When the input of the manipulation signal is started, (i) manipulation positions on the manipulation surfaces of the right touchpad 52 and left touchpad 53 and (ii) manipulation pressures on the manipulation positions are corresponded to each other and plotted virtually on the manipulation surfaces (S110). As explained above, manipulation positions are positions which the driver touches or to which the driver performs a manipulation; manipulation pressures on the manipulation positions are pressures which are applied to the manipulation positions based on the manipulation performed by the driver. The plotting is performed on a memory (not shown) connected to the CPU 13.

Next, the CPU 13 determines whether an amount of data required, e.g., to identify a manipulatable range from the plotted manipulation positions (an amount of data required to perform S120 to S130 mentioned later accurately) has been prepared (S115). Specifically, for example, the preparation may be determined from that the plotted area has been a predetermined area or more, that the number of the manipulations has been a predetermined number or more, and that a predetermined time has elapsed. The processing proceeds to S120 when the CPU 13 determines that the required amount of data has been prepared (S115: Yes). The processing returns to S110 when the CPU 13 determines that the required amount of data has not been prepared (S115: No).

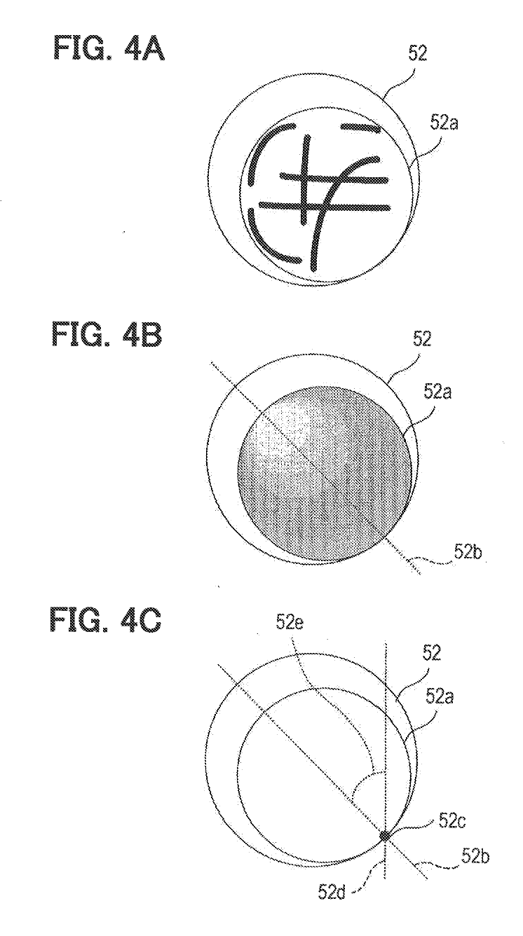

At S120 to which the processing proceeds when the CPU 13 determines that the required amount of data has been prepared, a manipulatable range is identified from the plotted manipulation positions. Thus, S120 executed by the CPU 13 may function as a manipulatable range identification section, device, or means. This is identification of a range actually manipulated by the driver on the manipulation surfaces of the right touchpad 52 and left touchpad 53. Here, the right touchpad 52 is explained specifically. FIG. 4A shows the right touchpad 52 viewed from the front, in which the black thick lines show trajectories manipulated (drawn or traced) by the driver with the thumb. From such a history of manipulation trajectories, an actually manipulated range (manipulatable range 52a) is identified.

Returning to FIG. 3, the CPU 13 creates a pressure map of the manipulation surfaces of the right touchpad 52 and left touchpad 53 (S125). In this map, a distribution of manipulation pressures by the driver is recorded correspondingly to the manipulatable range identified at S120. Here, the right touchpad 52 is explained specifically. FIG. 4B shows the right touchpad 52 viewed from the front, in which the pressure distribution is expressed by a tone. That is, the dark part has been manipulated by a relatively high pressure, and the light part has been manipulated by a relatively low pressure.

Returning to FIG. 3, the CPU 13 identifies an angle of the right and left thumbs of the driver (S130). This identification is to detect an angle of each thumb when the driver places hands on the steering wheel 51 to manipulate the right touchpad 52 and left touchpad 53. Here, the right touchpad 52 is explained specifically. FIG. 4C shows the right touchpad 52 viewed from the front, in which a thumb centerline 52b is along the centerline of the thumb. Various techniques to identify the thumb centerline 52b can be considered. For example, a position 52c of the base of the thumb may be found on the basis of a situation (degree of curve) of a trajectory of a curve drawn in the manipulatable range 52a. Then, a straight line that connects the position 52c and the farthest point from the position 52c in the manipulatable range 52a may be identified as the thumb centerline.

Thus, an angle 52e between the thumb centerline 52b identified as above and a vertical line 52d when the right touchpad 52 viewed from the front is identified as an angle of the thumb.

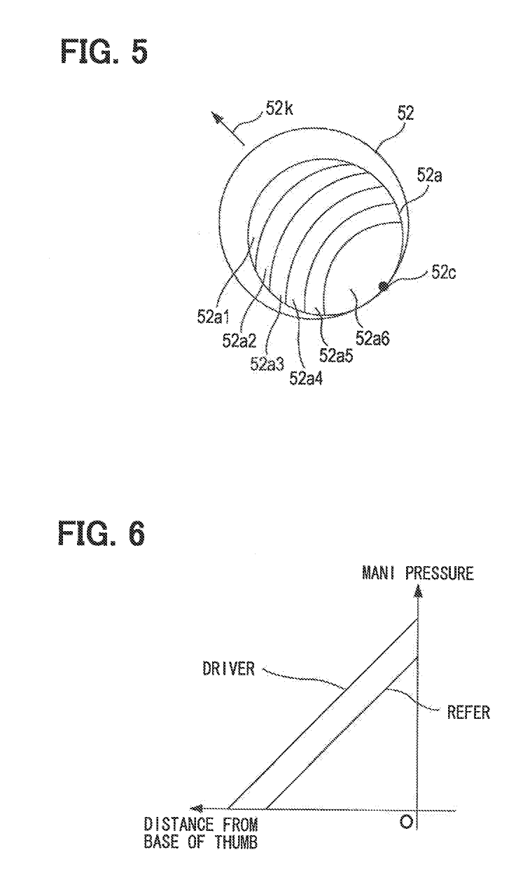

Returning to FIG. 3, the CPU 13 calculates compensation parameters on the basis of the results of S120 to S130 (S135). Thus, S135 executed by the CPU 13 may function as a compensation parameter identification section, device, or means. Specifically, an expansion rate is calculated to expand a manipulation made in the manipulatable range to the overall manipulation surface of the touchpad. In this case, an expansion rate may be calculated to uniformly expand a manipulation made in the manipulatable range irrespective of a position on the manipulation surface. The manipulatable range may be divided into multiple divisional areas. An expansion rate and an expansion direction may be calculated for each divisional area. That is, as shown in FIG. 5, the manipulatable range 52a is divided into six divisional areas 52a1 to 52a6 (hereinafter, also referred to as only “area” or “areas”) in a wave pattern relative to the position 52c of the base of the right thumb. The expansion rate and expansion direction are calculated for each area. Specifically, the area 52a1 has the largest expansion rate, and an expansion rate is calculated to decrease toward the area 52a6. The expansion direction is a thumb tip direction 52k, which may be also as an outward direction that directs from the base of the thumb toward the tip of the thumb.

On the basis of a pressure map as shown in FIG. 4B, a multiplier (magnification) of a manipulator's manipulation pressure relative to an average driver's manipulation pressure is calculated. The following technique can be considered as an example of the calculation technique. The horizontal axis shows a distance from the base of a thumb and the vertical axis shows manipulation pressures. The manipulation pressures on the thumb centerline 52b in FIG. 4B are linearly approximated and graphed to be a driver manipulation pressure line 61 (“DRIVER”) as shown in FIG. 6, for example. The average driver's manipulation pressures are linearly approximated and graphed to be a reference manipulation pressure line 62 (“REF”) as shown in FIG. 6, for example. The above multiplier (magnification) is calculated on the basis of these two lines. This calculated multiplier (magnification) is reflected in a coefficient of a compensation amount when the manipulation pressure increases.

A compensation angle to compensate a rotation of a manipulation by a driver is calculated from an angle of the thumb calculated by the technique as shown in FIG. 4C. As an example of the calculation technique, a technique to find a compensation angle corresponding to an angle of the thumb can be considered on the basis of a predetermined formula.

Returning to FIG. 3, the CPU 13 retrieves conformed learning data on the basis of the compensation parameters calculated at S135 (S140). Thus, S140 executed by the CPU 13 may function as a learning data identification section, device, or means. The learning data associated with the generally same compensation parameters as ones calculated at S135 is retrieved from the learning data stored in the storage portion 17. The learning data includes a frequently used manipulation, a gesture (combination between a predetermined manipulation and predetermined function), an order of candidates of input characters, etc., and is provided for each driver. Additional compensation parameters other than the above ones may also be contained as part of the learning data.

Instead of retrieving the learning data on the basis of the compensation parameters, the learning data may be retrieved on the basis of the results of S120 to S130, i.e., a manipulatable range, a pressure map, and an angle of the thumb. In this case, the results of S120 to S130 and the learning data may need to be stored in the storage portion 17 correspondingly to each other.

Then, the CPU 13 determines whether the conformed learning data has been found on the basis of the compensation parameters (S145). When the conformed learning data has been found (S145: Yes), the processing proceeds to S150, and when the conformed learning data has not been found (S145: No), the processing proceeds to S155.

At S150 to which the processing proceeds when the conformed learning data has been found, the conformed learning data is read out from the storage portion 17 and is set. Thus, S150 executed by the CPU 13 may function as a learning data output section, device, or means. Then, the learning data is used in association with manipulations hereinafter. Specifically, the learning data may be transmitted to the navigation apparatus 41 via the manipulation signal output portion 18 and used in the navigation apparatus 41 or/and in the control apparatus 11. Thus, the manipulation signal output portion 18 may be also referred to as a learning data output portion, device, or means.

On the other hand, at S155 to which the processing proceeds when the conformed learning data has not been found, the compensation parameters are stored in the storage portion 17 correspondingly to initial learning data. Hereinafter, conformed learning data about the same driver is retrieved at S140.

At S160 following S150 and S155, the compensation parameters calculated at S135 are set to be used for the compensation process. Hereinafter, the compensation parameters are used in the compensation process to compensate a manipulation signal, and the compensated manipulation signal is outputted to the navigation apparatus 41 via the manipulation signal output portion 18.

Next, the CPU 13 starts storage of the learning data (S165). Data such as a frequently used manipulation, a gesture (combination between a predetermined manipulation and a predetermined function), and an order of candidates of input characters are stored in the storage portion 17 correspondingly to the compensation parameters calculated at S135.

Next, the CPU 13 determines whether an ignition switch (or accessory switch) has been turned off (S170). When the CPU 13 determines that the ignition switch (or accessory switch) has been turned off, (S170: Yes), this processing (compensation parameter setting) ends. That is, the CPU 13 stops the input of the manipulation signal started at S105 and the storage of the learning data started at S165.

On the other hand, when the CPU 13 determines that the ignition switch (or accessory switch) has not been turned off (S170: No), the processing remains at S170. That is, the storage of the learning data continues on the basis of the manipulation signal.

(2) Compensation Process

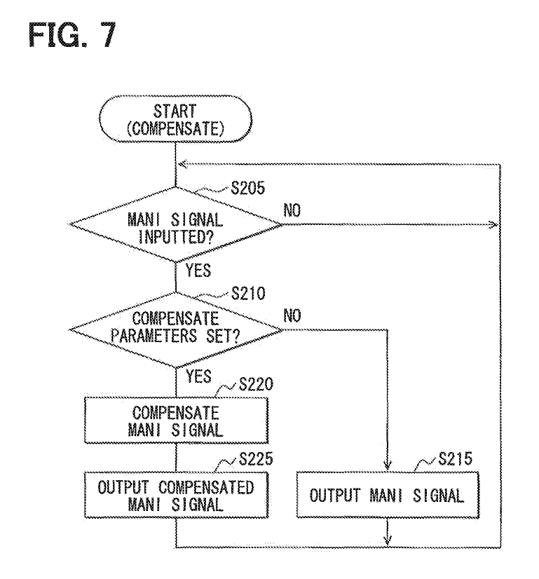

Next, the compensation process is explained using FIG. 7. The compensation process is performed by the CPU 13 on the basis of a program read from the storage portion 17. The compensation process is started when the ignition switch (or accessory switch) of the vehicle has been turned on.

The CPU 13 determines whether a manipulation signal has been inputted from the right pad sensor 31 or left pad sensor 32 via the sensor signal input portion 12 when the compensation process is started (S205). The manipulation signal includes a signal to identify a position (i.e., manipulation position) and pressure (i.e., manipulation pressure) of the manipulation made onto the manipulation surface of the right pad sensor 31 or left pad sensor 32.

When the CPU 13 determines that the manipulation signal has been inputted (S205: Yes), the processing proceeds to S210. In contrast, when the CPU 13 determines that no manipulation signal has been inputted (S205: No), the processing remains at S205.

At S210 to which the processing proceeds when the CPU 13 determines that the manipulation signal has been inputted, the CPU 13 determines whether the compensation parameters have been set. This determination is about whether S160 of the compensation parameter setting mentioned above has been performed.

When the CPU 13 determines that the compensation parameters has been set (S210: Yes), the processing proceeds to S220. In contrast, when the CPU 13 determines that no compensation parameter has been set (S210: No), the processing proceeds to S215.

At S215 to which the processing proceeds when the CPU 13 determines that no compensation parameter has been set, the manipulation signal inputted by the sensor signal input portion 12 is outputted to the navigation apparatus 41 via the manipulation signal output portion 18 without change. Then, the processing returns to S205 mentioned above.

On the other hand, at S220 to which the processing proceeds when the CPU 13 determines that the compensation parameters have been set, the manipulation signal inputted by the sensor signal input portion 12 is compensated on the basis of the compensation parameters. Thus, S220 executed by the CPU 13 may function as a compensation section, device, or means.

An example of the compensation is explained below.

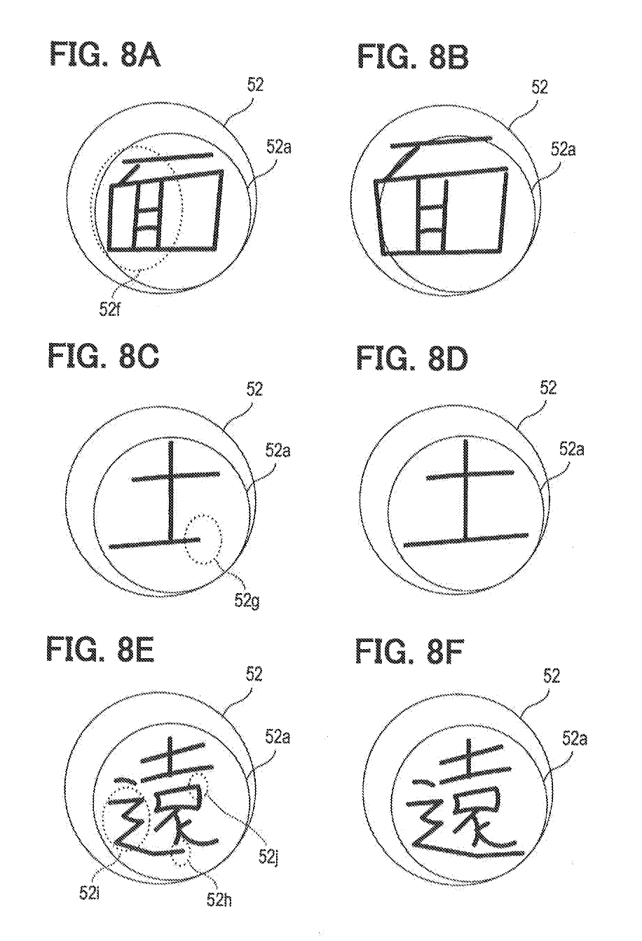

The Japanese kanji character “ [symbol] ” signifying “face” in English is written on the manipulatable range 52a of the right touchpad 52 in FIG. 8A. Part of the Japanese kanji character surrounded by a dashed line 52f has been distorted. The area around a manipulating fingertip is easier to exactly manipulate than the area around the base of the manipulating finger. The driver is likely to primarily manipulate the area around the fingertip. Therefore, when writing a character on the manipulation surface, there is a tendency to write a character more closely (i.e., shrinked) in the area around the fingertip than in the area around the base of the finger. Therefore, the part surrounded by the dashed line 52f is strained.

FIG. 8B shows a character after the character written as shown in FIG. 8A has been compensated. The strain is canceled in and around the strained area surrounded by the dashed line 52f in FIG. 8A. That is, the manipulation trajectories are expanded in and around the area surrounded by the dashed line 52f.

FIG. 8C shows the Japanese kanji character “ [symbol] ” signifying “soil” in English is written on the manipulatable range 52a of the right touchpad 52. The part surrounded by a dashed line 52g is shorter than the usual “ [symbol] .” On the manipulation surface of the right touchpad 52, the area around the base of the manipulating finger (the lower right of FIG. 8C) is more difficult to manipulate than the area around the manipulating fingertip (the upper left of FIG. 8C). In and around the area surrounded by the dashed line 52g, the manipulation pressure increases and the manipulation trajectories are short.

FIG. 8D shows a character compensated from the character written as shown in FIG. 8C. Here, the short part of the character surrounded by the dashed line 52g in FIG. 8C has been prolonged.

In FIG. 8E, the Japanese kanji character “ [symbol] ” signifying “distant” in English has been written on the manipulatable range 52a of the right touchpad 52. The part surrounded by the dashed line 52h is shorter than the usual character. On the manipulation surface of the right touchpad 52, the area around the base of the manipulating finger (the lower right of FIG. 8E) is harder to manipulate than the area around the manipulating fingertip (the upper left of FIG. 8E). Therefore, the manipulation pressure increases and the manipulation trajectory is short in and around the part surrounded by the dashed line 52h.

FIG. 8F shows a character compensated from the character written as shown in FIG. 8E. While the short part of the character surrounded by the dashed line 52h in FIG. 8E has been prolonged, there is no change in the parts surrounded by the dashed lines 52i and 52j. That is, the manipulation pressure is likely to increase in the part applied with a fine manipulation, e.g., in the part surrounded by the dashed line 52i, but compensation in response to the manipulation pressure is not made in the part surrounded by the dashed line 52i. The manipulation pressure is likely to increase also in the part surrounded by the dashed line 52j, but compensation in response to the manipulation pressure is not made in the part surrounded by the dashed line 52i. When a zigzag manipulation is made in a relatively small area or when a manipulation whose direction is changed at a right angle (or approximately right angle) is made, no compensation is made.

The manipulation trajectories written on the manipulatable range 52a of the right touchpad 52 is compensated to rotate about the generally center point of the manipulation surface or manipulatable range 52a of the right touchpad 52. This process is not shown.

Returning to FIG. 7, at S225, the CPU 13 outputs the manipulation signal compensated at S220 to the navigation apparatus 41 via the manipulation signal output portion 18. Thus, S225 executed by the CPU 13 may function as a compensated signal output section, device, or means; the manipulation signal output portion 18 may be also referred to as a compensated signal output portion, device, or means. Then, the processing is returned to S205 mentioned above.

### Advantageous Effect of Embodiment

In the control apparatus 11 of the above embodiment, on the basis of a driver's manipulatable range, a manipulation signal is compensated to expand a manipulation trajectory. Therefore, the navigation apparatus 41 can recognize a manipulation content more precisely by use of the compensated signal.

Since the area around a manipulation fingertip on the manipulation surface of the touchpad is easier to finely manipulate than the area around the base of the manipulation finger, the driver is likely to primarily manipulate the area around the manipulation fingertip. Therefore, strain arises in a manipulation content (for example, a character written on the manipulation surface). Since the control apparatus 11 performs compensation to increase an expansion rate of a manipulation trajectory in an outward direction advancing from the base of the manipulating finger toward the manipulating fingertip on the manipulation surface of the touchpad while the steering wheel is being held, the above strain can be reduced.

The control apparatus 11 performs compensation, by the same compensation amount, for every multiple divisional areas into which the manipulation surface has been divided. Therefore, an amount of calculations of compensations can be reduced in comparison to the case in which a computation amount is changed correspondingly to each manipulation position on the manipulation surface. Additionally, the hardware structure of the control apparatus 11 can be simplified.

Each divisional area is obtained by division of the manipulation surface and arranged on the manipulation surface of the touchpad in a wave pattern in an outward direction advancing from the base of the manipulating finger toward the manipulating fingertip. It is supposed that, in usual, positions at the same distance from the base of the manipulating finger on the touch panel are manipulated by the similar manipulation feeling and degrees of the above strains are similar. Therefore, when the areas are obtained by the division as mentioned above, the hardware structure of the control apparatus 11 can be simplified accurately.

In the horizontal drawing (e.g., in a direction approaching a base of the finger) on the manipulation surface of the touchpad toward the end of the manipulation, an angle of the manipulating finger is further separated or more different from a position of a natural state of the finger to pressure the finger. Thus, the movement amount is likely to be reduced at the end of the manipulation. In the manipulation having a high manipulation pressure at the end of the horizontal manipulation on the manipulation surface of the touchpad, the control apparatus 11 compensates the signal as if the horizontal manipulation has continued further. Therefore, in the navigation apparatus 41, the outputted signal approaches a signal corresponding to the manipulation intended by a manipulator to increase a recognition accuracy of a manipulation content.

Due to the positional relationship between the steering wheel and touchpad (in other words, “the positional relationship between a position of the base of the manipulation finger and the center position of the touchpad at the time of manipulation.”), even when the manipulator draws a horizontal line on the manipulation surface of the touchpad, it is assumed that the drawn line is likely to incline. The control apparatus 11 compensates the signal to rotate a manipulation on the manipulation surface of the touchpad by a predetermined angle about the generally central point on the manipulation surface or in the manipulatable range. Therefore, in the control apparatus 11, the above inclination is reduced and the recognition accuracy of the navigation apparatus 41 of a manipulation content improves.

### Another Embodiment

Next, another embodiment is explained. The structures compatible with each other in the above-mentioned embodiment and the following embodiment can be combined with each other.

(1) Temporary Stop of Compensation

The CPU 13 of the control apparatus 11 may acquire information to determine whether a vehicle is in a stopping state, which may include an idle state, from a speed sensor or a shift position sensor via the in-vehicle LAN communication portion 21, for example. On the basis of the acquired information, the CPU 13 determines whether the vehicle is in the stopping state, and when the vehicle is in the stopping state, the CPU 13 temporarily stops the compensation mentioned above. Thus, the in-vehicle LAN communication portion 21 may be also referred to as a vehicle state information acquisition portion, device, or means.

The reason of the temporal stop is as follows. The driver performs a manipulation in the steering-wheel holding state without getting the hands off of the steering wheel, so that the above strain is likely to occur in the manipulation. The driver can release the steering wheel in the vehicle stopping state. For example, the manipulation may be made by use of the forefinger to generate little strain.

The compensation is temporarily stopped as mentioned above to ease the unwanted decrease of the recognition accuracy of the manipulation content by the compensation.

(2) Reduction Compensation

The CPU 13 of the above embodiment divides the manipulatable range 52a into the six areas 52a1 to 52a6 in a wave pattern on the basis of the position 52c of the base of the right thumb (i.e., in an outward direction from a base of a finger toward a tip of the finger), as shown in FIG. 5. An expansion rate and an expansion direction are calculated for each area. Specifically, the area 52a1 has the largest expansion rate, and the expansion rate is calculated to decrease toward the area 52a6 (i.e., in an inward direction from a tip of a finger toward a base of the finger). By calculating the expansion rate in this way, a manipulation made in the manipulatable range 52a is compensated to approach a manipulation initially intended by the driver.

On the contrary, the area 52a1 may have the smallest reduction rate, and the reduction rate may be calculated to increase toward the area 52a6. The compensation may be made using this reduction rate. The same advantageous effect is obtained also in this way.

(3) Consideration of Use of Gloves

The driver may drive with groves for cold protection, hand protection, sun protection, etc. In that case, a manipulation pressure changes as compared with a case where no glove is worn, and thus inconvenience may arise in the identification of a driver, i.e., learning data.

Therefore, when the CPU 13 retrieves learning data about a manipulation pressure, the CPU 13 may consider wear of gloves. Specifically, a manipulation pressure corresponding to each position on the manipulation surface does not change largely when gloves are worn. Therefore, the learning data about the manipulation pressure may be retrieved among the compensation parameters only by use of the trend in change of the manipulation pressure. In another way, a parameter about the manipulation pressure may be rejected from the compensation parameters. On the basis of a value of a sensor provided to the steering wheel to measure a resistance of a hand, an ambient temperature, a vehicle room temperature, etc., it is determined whether gloves are worn. Only when it is determined that gloves have been on, only the parameter about the manipulation pressure may be removed from the compensation parameters used to retrieve learning data.

Thus, when wear of gloves is taken into consideration, an accuracy to identify learning data increases.

(4) Double-Sided Use of Both Sides of Touchpad

The right touchpad 52 and left touchpad 53 have a generally disk shape. Manipulations may be made not only from the front surface (driver's side) but also from the back side (front side of the vehicle). The right pad sensor 31 and the left pad sensor 32 may detect manipulations from the back sides of the corresponding touchpads distinguishably. Then, the CPU 13 may perform compensation equivalent to that of the above first embodiment for manipulation signals from the back sides.

In this way, the driver can perform more complicated manipulations, and a recognition accuracy of manipulation contents can be improved.

(5) Unification of Control Apparatus 11 and Navigation Apparatus 41

The control apparatus 11 and the navigation apparatus 41 may be unified. For example, the control apparatus 11 or its functions may be built in the navigation apparatus 41. Even in this case, the same advantageous effect as other cases is obtained.

Aspects of the disclosure described herein are set out in the following clauses.

According to a first aspect of the present disclosure, according to an embodiment of the present discloser, a control apparatus for a vehicle is provided to include an input portion, a manipulatable range identification section, a compensation section, and a compensated signal output portion. The input portion inputs a signal based on a manipulation performed on a manipulation surface of a touchpad, which is positioned to be manipulatable in a steering-wheel holing state that is a state where a steering wheel of the vehicle is held by a hand of a driver of the vehicle. The manipulatable-range identification section identifies a manipulatable range on the manipulation surface of the touchpad based on the signal inputted by the input portion. The compensation section compensates the signal based on the manipulatable range to expand or reduce a manipulation trajectory identified by the signal inputted by the input portion. The compensated signal output portion outputs the signal compensated by the compensation section. The above “signal” may be analog or digital. The compensated signal may be outputted to a control apparatus having a different function.

According to a second aspect being optional, the manipulatable range identification section may identify the manipulatable range from a history of manipulation positions on the manipulation surface of the touchpad.

According to a third aspect being optional, when the compensation section compensates the signal to expand the manipulation trajectory, the signal may be compensated to increase, along an outward direction, an expansion rate of the manipulation trajectory on the manipulation surface of the touchpad. The outward direction advances from a base of a manipulating finger under the steering-wheel holding state where the steering wheel is held toward a tip of the manipulating finger.

On the manipulation surface of the touchpad, an area around the tip of the manipulating finger is easy to finely manipulate in comparison, to an area around the base of the manipulating finger. Therefore, the driver is likely to primarily manipulate the area near the tip of the manipulating finger. Therefore, a strain is generated in a manipulation content (for example, a character written on the manipulation surface).

As a result, when the signal is compensated to increase an expansion rate of the manipulation trajectory from the base toward tip of the manipulation finger while the steering wheel is being held, the strain of the manipulation content can be reduced.

Alternatively to the third example, according to a fourth aspect being optional, when the compensation section compensates the signal to reduce the manipulation trajectory, the signal may be compensated to increase, in an inward direction, a reduction rate of the manipulation trajectory on the manipulation surface of the touchpad, the inward direction advancing from a tip of the manipulating finger under the steering-wheel holding state toward a tip of the manipulating finger toward a base of the manipulating finger.

According to a fifth aspect being optional, the compensation section may compensate the signal by assigning a divisional-area-specific compensation amount with respect to each of a plurality of divisional areas into which the manipulation surface is divided.

That is, as a compensation technique, although a compensation amount may be changed with respect to each manipulation position on the manipulation surface, compensation may be made by the same amount for each divisional area of the manipulation surface.

In this way, in comparison to changing of a compensation amount with respect to each manipulation position on the manipulation surface, an amount of compensation calculations can be reduced to simplify a hardware structure of the control apparatus.

According to a sixth aspect being optional, the divisional areas may be arranged, in a wave pattern propagating in an outward direction, on the manipulation surface of the touch pad. The outward direction advances from a base of a manipulating finger under the steering-wheel holding state toward a tip of the manipulating finger.

Usually, a position of the base of the manipulating finger is fixed relative to the touchpad. Then, the finger moves about this position to manipulate the touchpad. Therefore, a similar manipulation feeling can be obtained in the divisional areas on the touchpad in the same distance from the base position. It is assumed that the above strain is also generated to a similar degree. Therefore, when the divisional areas are obtained by division as mentioned above, the hardware structure of the control apparatus can be simplified while securing sufficient accuracy.

According to a seventh aspect being optional, the touchpad may detect a manipulation pressure. When a manipulation pressure in a horizontal manipulation on the manipulation surface of the touchpad is increased to a predetermined amount at an end of the horizontal manipulation, the compensation section may further compensate the signal as if the horizontal manipulation has continued further.

That is, when the manipulation surface of the touchpad is drawn or traced with a manipulation finger horizontally, the manipulation finger may be angled separately or differently from a natural position of the finger toward the end of the manipulation. In this case, the finger is pressured and its movement amount is likely to be reduced. Therefore, in the manipulation having a high manipulation pressure at the end of the horizontal manipulation on the manipulation surface of the touchpad, the signal is preferably further compensated as if the horizontal manipulation has continued further. The above likeliness is especially remarkable in the horizontal direction approaching the base of the manipulating finger among the several horizontal directions. The signal may be compensated only in the direction approaching the base of the manipulating finger as if the horizontal manipulation has continued further.

In this way, the outputted signal approaches a signal corresponding to a manipulation intended by a manipulator to increase a recognition accuracy of a manipulation content.

According to an eighth aspect being optional, the compensation section may further compensate the signal to rotate a manipulation on the manipulation surface of the touchpad by a predetermined angle about a central point of the manipulation surface or manipulatable range.

That is, due to the positional relationship between the steering wheel and touchpad (i.e., “the positional relationship between the base of the manipulation finger and the center of the touchpad at the time of manipulation”), even when the manipulator traces the manipulation surface of the touchpad with a finger to draw a horizontal line, it is assumed that the drawn line is likely to incline. Therefore, the signal is preferably compensated to rotate a manipulation on the manipulation surface of the touchpad by a predetermined angle about the generally central point of the manipulation surface or manipulatable range.

In this way, the above inclination is reduced and recognition accuracy of the manipulation content is improved.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A control apparatus for a vehicle, the control apparatus comprising:
an input portion that inputs a signal based on a manipulation performed on a manipulation surface of a touchpad, which is positioned to be manipulatable in a steering-wheel holding state that is a state where a steering wheel of the vehicle is held by a hand of a driver of the vehicle;
a manipulatable range identification section that identifies a manipulatable range on the manipulation surface of the touchpad based on the signal inputted by the input portion;
a compensation section that compensates the signal based on the manipulatable range to expand or reduce a manipulation trajectory identified by the signal inputted by the input portion; and
a compensated signal output portion that outputs the signal compensated by the compensation section.

2. The control apparatus according to claim 1, wherein:
the manipulatable range identification section identifies the manipulatable range from a history of manipulation positions on the manipulation surface of the touchpad.

3. The control apparatus according to claim 1, wherein:
when the compensation section compensates the signal to expand the manipulation trajectory, the signal is compensated to increase, along an outward direction, an expansion rate of the manipulation trajectory on the manipulation surface of the touchpad, the outward direction advancing from a base of a manipulating finger under the steering-wheel holding state toward a tip of the manipulating finger.

4. The control apparatus according to claim 1, wherein:
when the compensation section compensates the signal to reduce the manipulation trajectory, the signal is compensated to increase, in an inward direction, a reduction rate of the manipulation trajectory on the manipulation surface of the touchpad, the inward direction advancing from a tip of the manipulating finger under the steering-wheel holding state toward a tip of the manipulating finger toward a base of the manipulating finger.

5. The control apparatus according to claim 1, wherein:
the compensation section compensates the signal by assigning a divisional-area-specific compensation amount with respect to each of a plurality of divisional areas into which the manipulation surface is divided.

6. The control apparatus according to claim 5, wherein:
the divisional areas are arranged, in a wave pattern propagating in an outward direction, on the manipulation surface of the touch pad, the outward direction advancing from a base of a manipulating finger under the steering-wheel holding state toward a tip of the manipulating finger.

7. The control apparatus according to claim 1, wherein:
the touchpad detects a manipulation pressure; and
when a manipulation pressure in a horizontal manipulation on the manipulation surface of the touchpad is increased to a predetermined amount at an end of the horizontal manipulation, the compensation section further compensates the signal as if the horizontal manipulation has continued further.

8. The control apparatus according to claim 1, wherein:
the compensation section further compensates the signal to rotate a manipulation on the manipulation surface of the touchpad by a predetermined angle about a central point of the manipulation surface or manipulatable range.

9. The control apparatus according to claim 1, further comprising:
a compensation parameter identification section that identifies compensation parameters used when the compensation section performs a compensation;
a storage portion that stores learning data about manipulations correspondingly to the compensation parameters for each manipulator;
a learning data identification section that identifies learning data stored in the storage portion on a basis of the compensation parameters identified by the compensation parameter identification section; and
a learning data output portion that outputs learning data identified by the learning data identification section.

10. The control apparatus according to claim 1, further comprising:
a vehicle state information acquisition portion that inputs an information about whether a vehicle is in a traveling state or in a stopping state,
wherein the compensation section performs a compensation when the information acquired by the vehicle state information acquisition portion shows that the vehicle is in the traveling state, and performs no compensation when the information shows that the vehicle is in the stopping state.

11. A method for compensating a manipulation on a touchpad in a vehicle, the method being computer-implemented for execution by a computer,
the method comprising:
inputting a signal based on a manipulation performed on a manipulation surface of the touchpad, which is positioned to be manipulatable in a steering-wheel holing state that is a state where a steering wheel of the vehicle is held by a hand of a driver of the vehicle;
identifying a manipulatable range on the manipulation surface of the touchpad based on the signal inputted;
compensating the signal based on the manipulatable range to expand or reduce a manipulation trajectory identified by the signal inputted; and
outputting the signal that is compensated.

12. A program product stored in a non-transitory computer readable storage medium comprising instructions for execution by a computer, the instructions including the method according to claim 11, the method being computer-implemented.
